(19) United States
(12) Patent Application Publication
(10) Pub. No.: US 2016/0227917 A1
(43) Pub. Date: Aug. 11, 2016

(54) HAND WASHING DEVICE

(71) Applicant: BoBear LLC, Boston, MA (US)

(72) Inventors: Kelly Stuart, Boston, MA (US); Jonathan Stuart, Boston, MA (US); Hadley Stuart, Boston, MA (US); Marcel Botha, New York, NY (US)

(73) Assignee: BoBear LLC, Boston, MA (US)

(21) Appl. No.: 15/015,229

(22) Filed: Feb. 4, 2016

Related U.S. Application Data
(60) Provisional application No. 62/112,612, filed on Feb. 5, 2015.

(51) Int. Cl. A46B 15/00; B25G 1/10

(52) U.S. Cl. CPC A46B 15/004; B25G 1/102; A46B 15/0044; A46B 15/0046

(57) ABSTRACT

An apparatus and method for hand washing is disclosed. In some embodiments, a hand washing device includes a body graspable by a user; at least one of a speaker, light and vibration mechanism disposed in the body; and a washing surface attached to the body. In some embodiments, the hand washing device alerts the user with the at least of the speaker, light and vibration mechanism to entice people to wash their hands, and to enhance engagement and focus during hand washing.

### CROSS-REFERENCE TO RELATED APPLICATIONS

This application claims the benefit under 35 U.S.C. §119(e) to U.S. Provisional Application No. 62/112,612, entitled “HAND WASHING DEVICE” filed on Feb. 5, 2015, which is herein incorporated by reference in its entirety.

### FIELD

The disclosed embodiments are generally directed to hand washing devices and more particularly to devices that encourage hand washing and hygiene.

### BACKGROUND

Various hand washing devices are used to encourage hand washing. For example a user may hold a toy with a mesh pocket for soap and sponge holder. A user also may hold a video controller configured to operate while kept wet during hand washing. Such systems used to encourage hand washing, however, do not provide a satisfactory solution in all aspects.

### SUMMARY

According to one embodiment, a hand washing device is disclosed. The hand washing device includes a body graspable by a user, at least one of a speaker, light, and vibration mechanism disposed in the body, and a washing surface attached to the body.

According to another embodiment, a method of hand washing is disclosed. The method includes grasping a hand washing device, the device having a body, a washing surface, and at least one of a speaker, light and vibration mechanism disposed in the body, activating the device, alerting a user with at least one of the speaker, light and vibration mechanism to wash a first hand, washing the first hand with the washing surface, alerting the user with at least one of the speaker, light and vibration mechanism to wash a second hand, washing the second hand with the washing surface, and alerting the user with at least one of the speaker, light and vibration mechanism to stop washing the second hand.

It should be appreciated that the foregoing concepts, and additional concepts discussed below, may be arranged in any suitable combination, as the present disclosure is not limited in this respect.

The foregoing and other aspects, embodiments, and features of the present teachings can be more fully understood from the following description in conjunction with the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of a hand washing device according to one embodiment;

FIG. 2 is a side view of the hand washing device of FIG. 1;

FIG. 3 is a side view of a hand washing device according to another embodiment;

FIG. 4 is an exploded view of the hand washing device of FIG. 1;

FIG. 5 is a cross sectional side view of a hand washing device according to another embodiment; and

FIG. 6 is a cross sectional side view of a hand washing device according to another embodiment.

### DETAILED DESCRIPTION OF INVENTION

Hand washing is essential to good hygiene and helps prevent the spreading of germs to others. Some people, such as young children, are reluctant to take the time to properly wash their hands. A solution to this problem is disclosed herein and includes a device with multiple modes of interaction to entice people to wash their hands, and to enhance engagement and focus during hand washing. Embodiments disclosed herein include a hand washing device that incorporates sound (e.g., voice and music), vibration, or light (e.g., white or colored), or combinations thereof, to promote and focus hand washing behavior in a user. The hand washing device may encourage compliance for young users (e.g., children) developing focus and dexterity and also may improve compliance and hand washing behavior of the young users over time. As will be appreciated, the improvement in compliance may have a direct health benefit to the young users and also to other individuals that interact with the young users (e.g., family members and/or classmates). The hand washing device also may be used to encourage and improve compliance and hand washing behavior in adults.

In some embodiments, the hand washing device is integral to the hand washing experience. That is, the hand washing device may be configured to make timing and engagement features part of the hand washing experience. The hand washing device also may include feedback sequences that give the user the ability to both time and sequence their hand washing actions. For example, the feedback sequences may encourage the user to focus on a specific hand washing task for a period of time corresponding to a prescribed duration of that task. As will be appreciated, this may improve compliance and reinforce the learning of long-term positive habits.

The hand washing sequences (e.g., a complete hand washing protocol) may last between 30 and 40 seconds, although the sequences may last more or less time. For example, the sequences may last between about 20 and 40 seconds, between about 10 and 30 seconds, or between about 40 and 60 seconds. In some embodiments, the sequences last about 30 seconds to allow young users who are new to using the device and do not have great dexterity ample time to wash their hands.

The different types of feedback (e.g., light, sound and/or vibrations) may be used as signals for desired activity. For example, light, sound, and/or vibration may be used to signal when to start and stop washing, as well as when to switch hands, wash the top and bottom of a hand, and wash the nails. In some embodiments, one or more types of feedback are used to signal each portion of the hand washing protocol (e.g., lights flash and music plays to signal each portion of the hand washing protocol). In other embodiments, different types of feedback may be used to indicate different portions of the protocol. For example, lights may flash to signal that a user should switch his/her hands while vibrations may be used to signal that a user should scrub his/her nails.

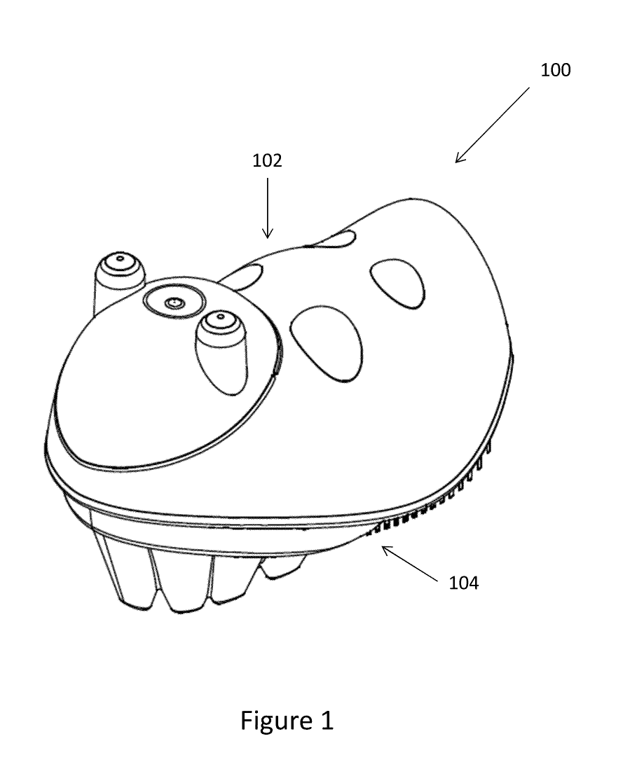

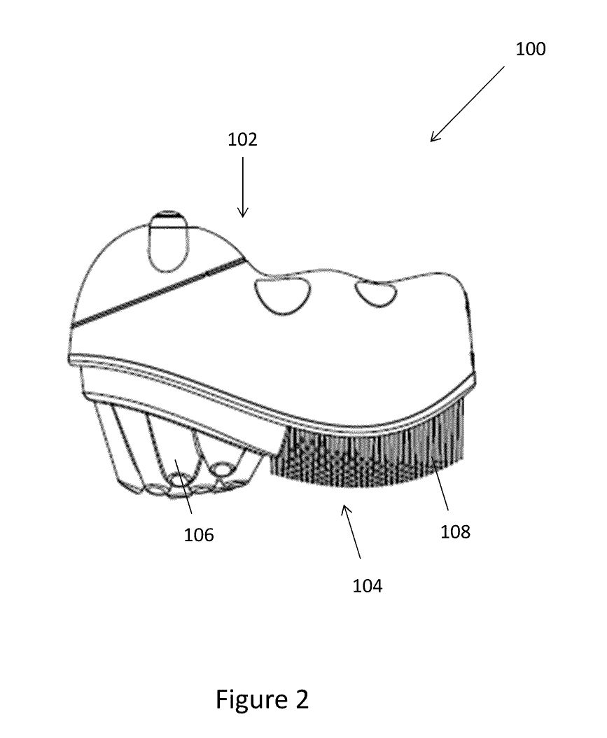

Turning now to the figures, FIG. 1 shows a perspective view of a hand washing device 100 according to one embodiment. As shown in this figure, the hand washing device 100 includes a body 102 that may be grasped by the hand of a user during use and a washing surface 104. Body 102 may have a rounded configuration to conform to the palm of a user. As illustrated in FIG. 2, the washing surface may include a sponge portion 106 and a bristle portion 108. The sponge portion 106 may improve lathering while the bristle portion 106 may improve scrubbing. For example, the sponge portion may be shaped to improve the active surface and volume and, thus, improve lathering performance. In such embodiments, a unique functional ratio balances the two washing portions to work in unison to improve cleaning of surfaces of a user's hand (e.g., the top and bottom of the hands, between the fingers, and under the nails).

Although the washing surface 104 is shown as having two washing portions (e.g., the sponge portion and the bristle portion) the washing surface 104 may include only one washing portion (e.g., only one sponge portion or one bristle portion) or may include three or more washing portions.

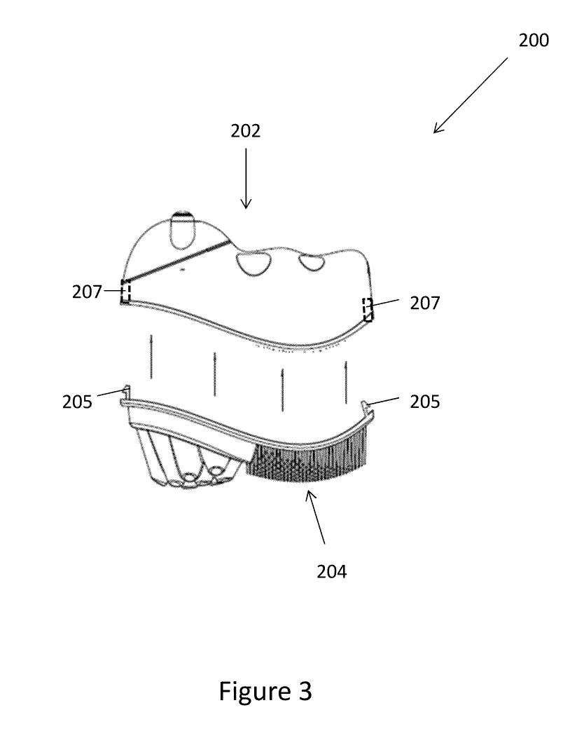

In some embodiments, as shown in FIGS. 1 and 2, the washing surface 104 is permanently attached to the body 102. In other embodiments, as shown in FIG. 3, the washing surface 204 may be removably attached to the body 202 of the device 200. In such embodiments, the washing surface 204 may be removed and replaced when needed (e.g., when dirty or after a prescribed period of time).

In some embodiments, the washing surface 204 is coupled to and decoupled from the body 202 using fasteners, such as fastener 205. The fastener 205 may include clips, snaps, or other suitable fastening arrangements for coupling and decoupling the washing surface 204 from the body 202. In some embodiments, the fastener 205 engages with a corresponding engagement member 207 in the body 202. Although two fasteners 205 are shown on the washing surface 204 in FIG. 3, the washing surface may have only one fastener or may have three or more fasteners in other embodiments. Also, although the washing surface 204 is shown as having fasteners 205 that engage with engagement members 207 in the body, in other embodiment, the body 202 may have fasteners that engage with engagement members in the washing surface 204.

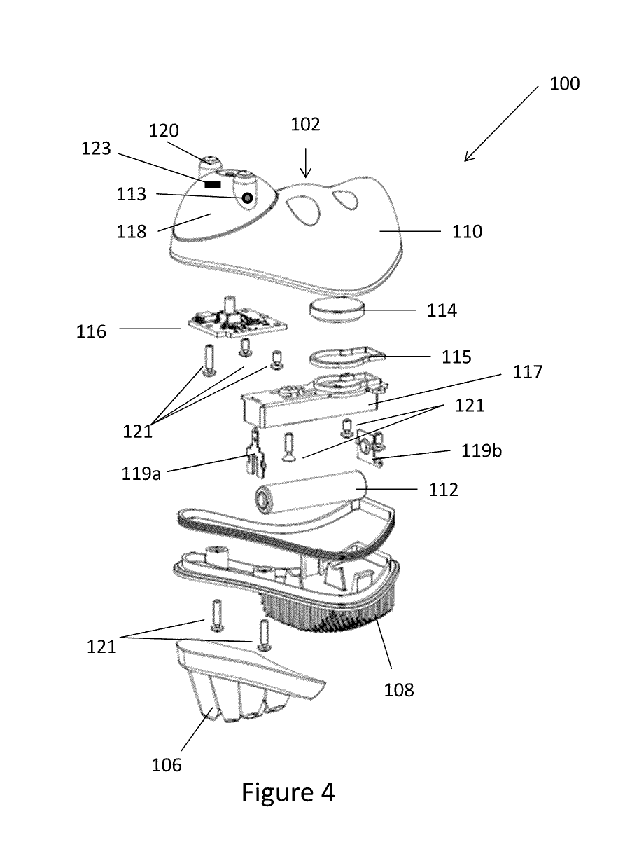

In some embodiments, the hand washing device may include a motor (not shown) that is configured to spin the bristles in the bristle portion 106 to enhance cleaning. In such embodiments, the bristles may be configured to spin when the device 100 is turned on. That is, the motor (not shown) may be activated when the user turns on the device 100. In some embodiments, the device may be turned on by pushing a button located on the body (see FIG. 4). For example, a user may push a button located between eyes on the head of the body. In other embodiments, the device may be turned on when the device senses a change in movement (e.g., is grasped and lifted up by the user). The device 100 also may be turned on when a change in moisture is sensed (e.g., when the device is rinsed under a tap).

FIG. 4 shows an exploded version of the hand washing device 100 of FIG. 1. As shown in FIG. 4, the body 102 may include an enclosure 110 (e.g., a clam shell enclosure) that houses one or more batteries 112, one or more speakers 114, a printed circuit board 116, and a switch. In some embodiments, the enclosure 110 includes one or more lights 113. The speaker 114 may be received in a speaker gasket 115. The batteries may be coupled to enclosure 110 via a battery tray 117 and connection terminals 119a, 119b. In some embodiments, the one or more batteries 112 are replaceable, although the batteries also may be rechargeable in other embodiments. In some embodiments, the batteries are permanently attached to the enclosure. Fixation members 121 (e.g., screws) may be used to attach the above-described components in the enclosure to one another and/or to the enclosure. In some embodiments, as previously described, the device 100 may include a power button 123, which, in some embodiments, may be pressed by the user to turn the device on and off.

Although the body 102 is shown as having one or more speakers 114 for audio feedback, in some embodiments, the body 102 may include additional sources for creating other types of feedback. For example, as described, the body 102 may include lights 113 for a visual feedback and/or a vibrating mechanism (not shown) for tactile feedback. As will be appreciated, in embodiments having more than one type of feedback, the device may include any combination of sound, light, vibrations or other suitable types of feedback.

In some embodiments, as shown in FIG. 4, the enclosure 110 may be covered in an over-molded rubber to improve the grip and dexterity during hand washing. The shape of the enclosure 110 may include an ergonomic form developed through functional research to allow for improved grasping by the user. In some embodiments, the device 100 is waterproof.

In some embodiments, the enclosure 100 is shaped like a creature (e.g., a bug), with the body including characteristics of the creature. For example, as shown in FIG. 4, the enclosure 110 may include a head 118 with eyes 120.

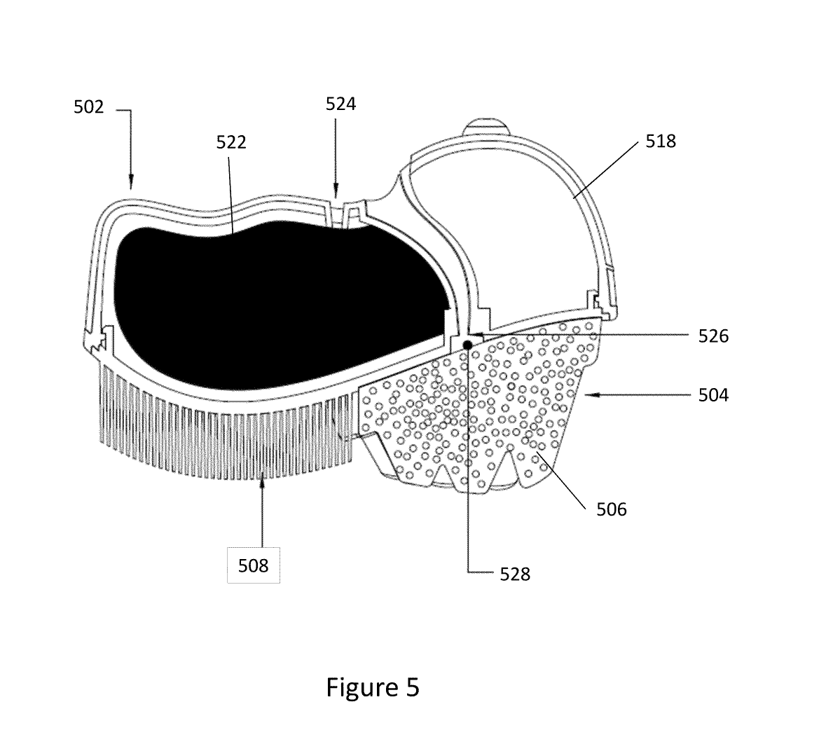

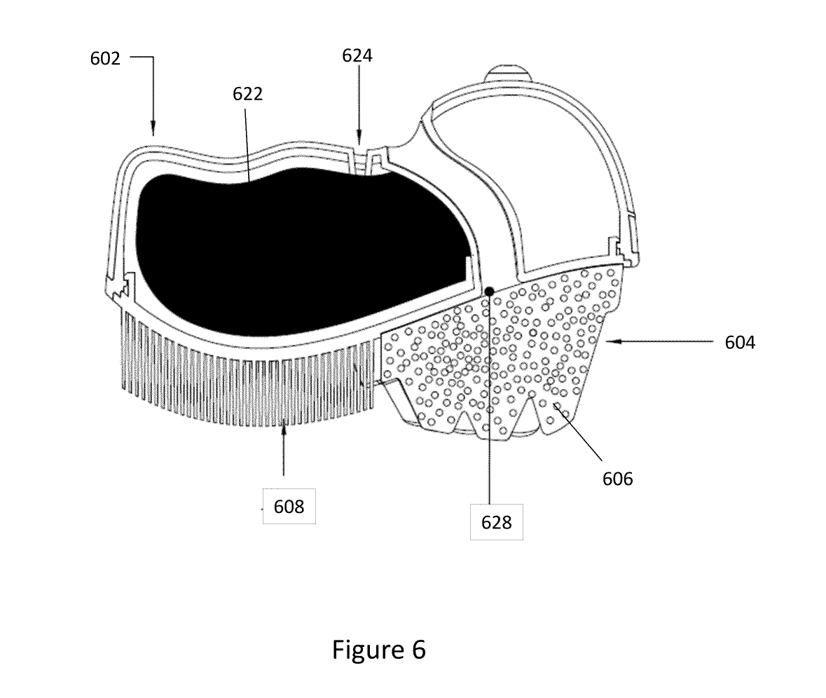

According to some embodiments, the hand washing device may be configured to dispense soap to the user. For example, in some embodiments, soap may be embedded into the washing surface (e.g., the sponge portion) and/or stored the body. In embodiments in which the soap is embedded in the washing surface 104 (e.g., the sponge portion 106), the washing surface 104 may include a soap-impregnated part that is removeable and replaceable when the soap has been used up. As shown in FIGS. 5 and 6, in embodiments in which the soap is stored in and dispensed from the body, the body 502, 602 includes a reservoir 522, 622, which may include a refill opening 524, 624, for adding soap into the reservoir 522, 622. As will be appreciated, devices with a reservoir 522, 622 may sealed or refillable.

In some embodiments, the reservoir is connected to an outlet 528 through which soap is dispensed. In some embodiments, as shown in FIG. 5, the body 502 may include a pivot point 526 for dispensing soap onto the washing surface 504 (e.g., onto the sponge 506) via the outlet 528. In such embodiments, pressure around the pivot point (e.g., pressure generated when the head 518 of the body 502 is rotated about the pivot point), pumps soap through the nozzle outlet 528 (e.g., from the reservoir). In other embodiments, pivoting of the head 518 about the body 502 may open a release point around the outlet 528 that allows soap to pass onto the washing surface 504 via the outlet (e.g., via passive pressure on the body 502). In other embodiments, as shown in FIG. 6, pressing down on the body 602 (e.g., squeezing the body at a location above the reservoir 622 to compress the reservoir and transfer soap from the reservoir to the outlet) or pushing a button (e.g., a button on the top of the body) also may dispense soap on to the washing surface 604 via an outlet 628. In some embodiments, the button may squeeze the reservoir 622 to dispense soap from the outlet. In other embodiments, the button may be used to dispense soap from the reservoir by activating a pump that transfers a measured volume of soap from the reservoir to the outlet. In some embodiments, the device may include a suction cup (not shown), for example, on a rear portion of the device, to allow the device to stand up on one end. In such an embodiment, the device may be positioned vertically, with the washing surface substantially perpendicular to a surface such as a countertop, or in some other position that exposes the washing surface to the air, to facilitate drying.

In some embodiments, the device may be connected (e.g., via a wireless or Bluetooth connection) to another device such as a computer or a smartphone or to an external network. This connection may allow the user to track use of the device and to reward the user for positive hand washing behavior (e.g., via a web site or via an application on the smartphone).

According to one embodiment, a method of using the device is disclosed. In such an embodiment, to wash his other hand, a user picks up the device 100 and presses the power button 123 (e.g., an on/off button). Lights 113, which may show through the spots, eyes, smile, and bottom rim, will start flashing or exhibit other behavior such as increasing and decreasing in intensity (e.g., getting brighter or duller) or running other light sequences. The user may then scrub his first hand (e.g., his left hand) with the sponge portion and bristle portion. The user may also clean his/her nails with the bristles. In one example, after 13 seconds, the lights 113 stop flashing and remain steady for 4 seconds, indicating that it is time for the user to switch hands. When the lights 113 start flashing again, the user may wash his other hand and nails until for the remaining 13 seconds, at which point the lights 113 turn off. In other embodiments, additional alerts such as sound or vibration may be used. These alerts may signal when to start washing, stop washing, change hands, wash front, wash back, and/or wash nails. In some embodiments, all alerts occur within a 40 second time period.

Although the hand washing protocol has been described with two, thirteen (13) second segments, the protocol may include one segment or three or more segments. The length of each segment (or of the alert) also may differ depending upon the hand washing protocol or the user (e.g., for children or adults). Further, although the segments are described as lasting for 13 seconds, the segments may last for more or less time. For example, each segment may last between about 5 and 20 seconds.

Although the hand washing device has been shown and described as having electronics that allow for one or more modes of interactions (e.g., sound, vibration, and light), in some embodiments, the hand washing device does not include any electronics.

That is, in some embodiments, the hand washing device may include the body and the hand washing surface. In other embodiments, the hand washing device may include the body, the hand washing surface and the soap dispenser (e.g., the reservoir and nozzle outlet for dispensing soap, as described above).

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A hand washing device comprising:
a body graspable by a user;
at least one of a speaker, light, and vibration mechanism disposed in the body; and
a washing surface attached to the body.

2. A method of hand washing, the method comprising:
grasping a hand washing device, the device having a body, a washing surface, and at least one of a speaker, light and vibration mechanism disposed in the body;
activating the device;
alerting a user with at least one of the speaker, light and vibration mechanism to wash a first hand;
washing the first hand with the washing surface;
alerting the user with at least one of the speaker, light and vibration mechanism to wash a second hand;
washing the second hand with the washing surface; and
alerting the user with at least one of the speaker, light and vibration mechanism to stop washing the second hand.
